(19) United States
(12) Patent Application Publication
(10) Pub. No.: US 2006/0181392 A1
(43) Pub. Date: Aug. 17, 2006

(54) Method and apparatus for accessing safe deposit box

(76) Inventor: Ronald R. Watson, Scottsdale, AZ (US)

Correspondence Address: TOD R. NISSLE, P.C., P.O. Box 55630, Phoenix, AZ, 85078, US

(21) Appl. No.: 11/057,773

(22) Filed: Feb. 14, 2005

(51) Int. Cl. G05B 19/00

(52) U.S. Cl. 340/5.73; 340/5.6

(57) ABSTRACT

A method and apparatus for accessing a safe deposit box stored in a vault. The safe deposit box includes a customer lock and a bank lock, each of which must be opened to access the box. Apparatus is provided to permanently maintain the bank lock in an open position and to enable a customer to enter the vault without requiring the assistance of a bank teller.

This invention relates to an apparatus and method for accessing a safe deposit box.

In a further respect, the invention relates to a method and apparatus for accessing a vault or other secure area to gain entry to a safe deposit box.

For over one hundred years, banks or other financial institutions routinely have maintained safe deposit boxes as a convenience for their customers. Safe deposit boxes are stored in a vault or in another secure area. The vault includes the main vault door, which ordinarily is open during bank business hours during the day and is closed when the bank is closed. When the main vault door is open, a teller or other bank personnel access the vault through a smaller door called a daygate.

Each safe deposit box includes a pair of locks. One lock on a safe deposit box, the customer lock, is opened with a key retained by a customer. The other lock on the box, the guard lock, is opened with a key, called a “guard-key”, retained by the bank or other financial institution. The function of the guard lock is to enable the customer lock. The customer lock can not be opened until the guard lock is opened. The function of the customer lock is to lock and unlock the safe deposit box. The safe deposit box can be opened and the box-tin removed only after the customer lock is opened. The guard lock can not be used to open the safe deposit box and remove the box-tin.

When a customer wishes to access his or her safe deposit box, the customer travels to the appropriate bank and asks a teller or other bank employee at the bank for assistance. The teller obtains the key to the vault daygate, obtains the bank's guard-key for the customer's safe deposit box, unlocks and opens the daygate to the bank vault for the customer, and, along with the customer, opens the customer's safe deposit box with the guard-key. The teller first uses the guard-key to open the guard lock, after which the customer uses the customer key to open the customer lock. The teller typically then either stands back or leaves to allow the customer to examine the contents of the customer's safe deposit box or to take the box-tin out of the safe deposit box and to a viewing room outside the vault. When the customer is ready to leave (if the customer examined the safe deposit box in the vault) or is ready to reenter the vault (if the customer examined the safe deposit box in a room outside the vault), the bank teller returns. The teller and the customer use their keys to lock the customer's box, after which both exit the vault. The customer first locks the customer lock. Then the teller locks the guard lock. The foregoing procedure is time-consuming and is likely, when many customers are waiting to examine their safe deposit boxes, to result in at least one customer who is upset with the bank because of the time required to access his or her safe deposit box. Banks have lost valuable customers because of the customers' ire at delays in accessing their safe deposit box.

Accordingly, it would be highly desirable to provide an improved apparatus and method for accessing a customer's safe deposit box.

Therefore, it is a principal object of the instant invention to provide an improved method and apparatus for accessing a safe deposit box.

A further object of the invention is to provide an improved method and apparatus for accessing a bank vault to gain entry to a safe deposit box in the vault.

Another object of the invention is to provide an improved method and apparatus for accessing a safe deposit box to reduce significantly the amount of time expended by a bank employee and by a customer in accessing the safe deposit box.

These and other, further and more specific objects and advantages of the invention will be apparent to those skilled in the art from the following detailed description thereof, taken in conjunction with the drawings, in which:

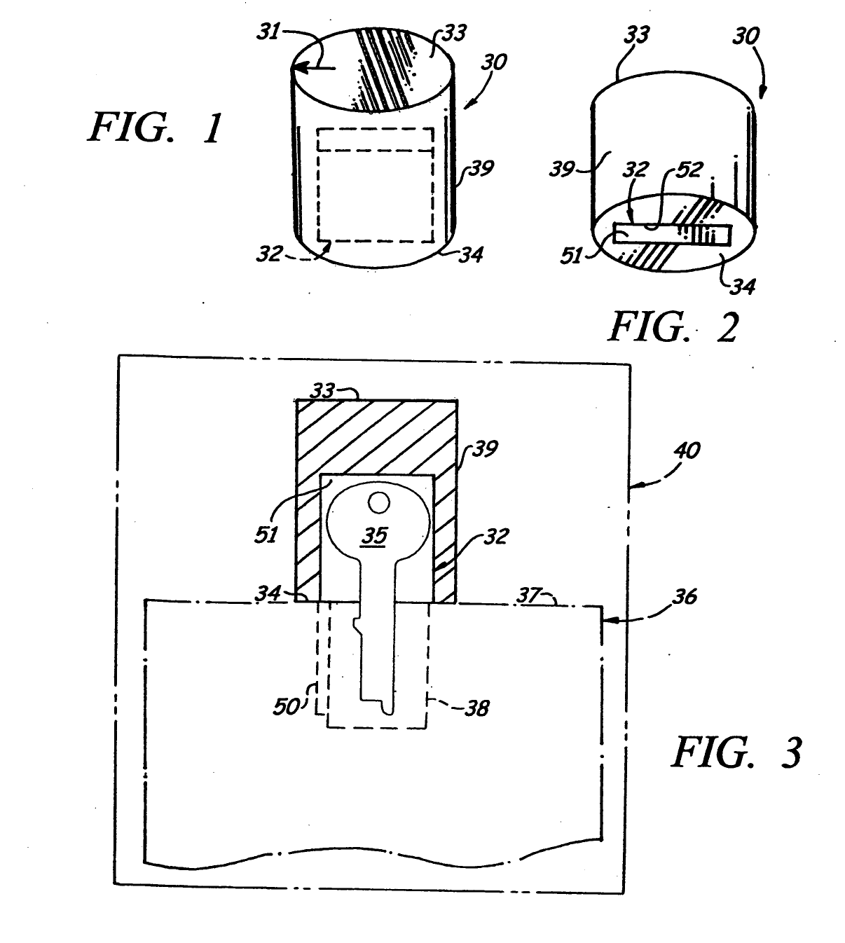

FIG. 1 is a top isometric view illustrating a key engaging apparatus utilized to facilitate access of a safe deposit box;

FIG. 2 is a bottom isometric view of the key engaging apparatus of FIG. 1 further illustrating construction details thereof;

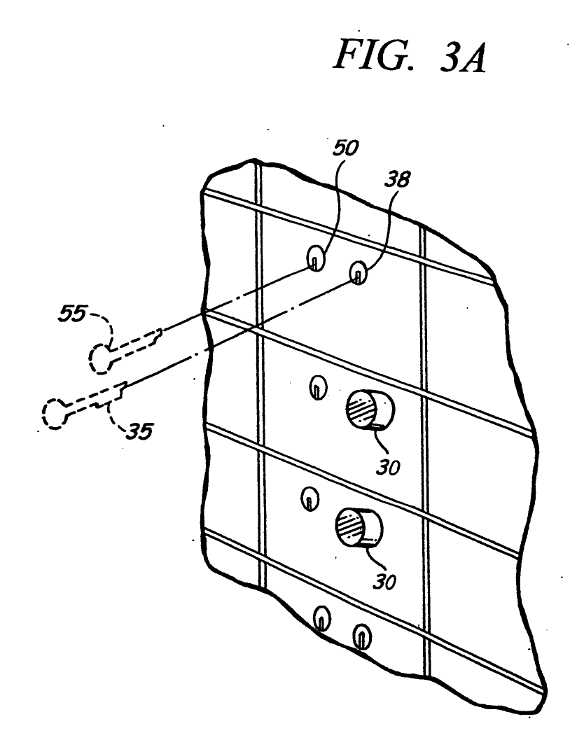

FIG. 3 is a side elevation view of the key engaging apparatus of FIGS. 1 and 2 illustrating the mode of operation thereof;

FIG. 3A is a perspective view illustrating a two key safe deposit box system adapted with the key engaging apparatus of the invention;

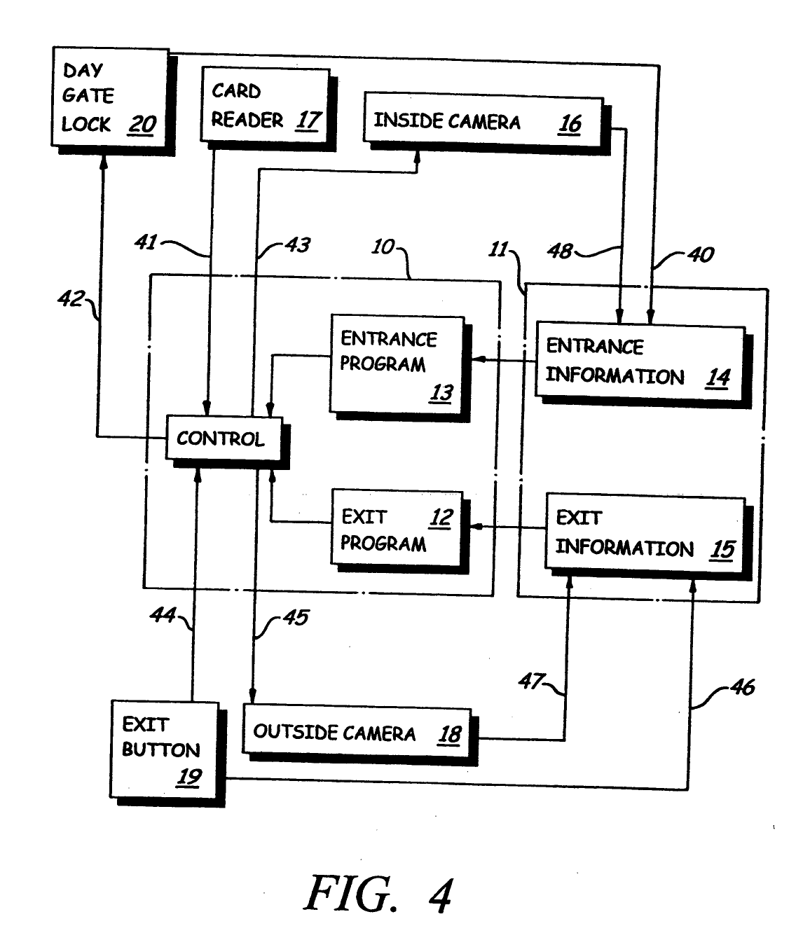

FIG. 4 is a block diagram illustrating safe deposit box accessing apparatus constructed in accordance with the invention;

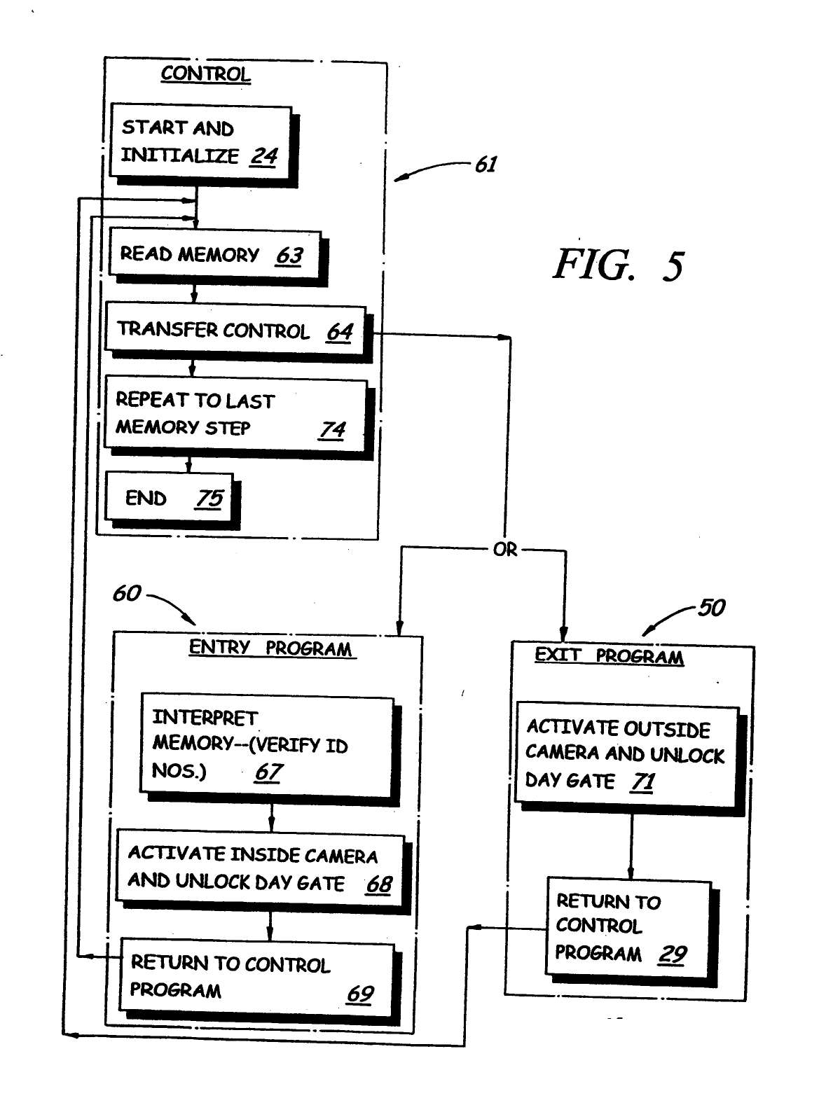

FIG. 5 is a logic flow diagram illustrating the mode of operation of software which can be utilized in the apparatus of FIG. 4;

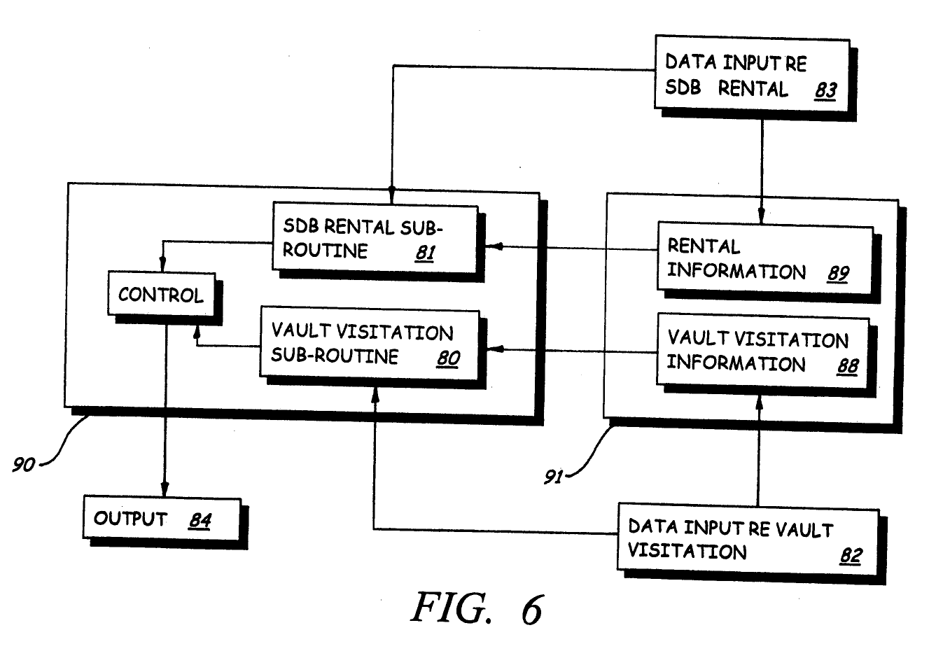

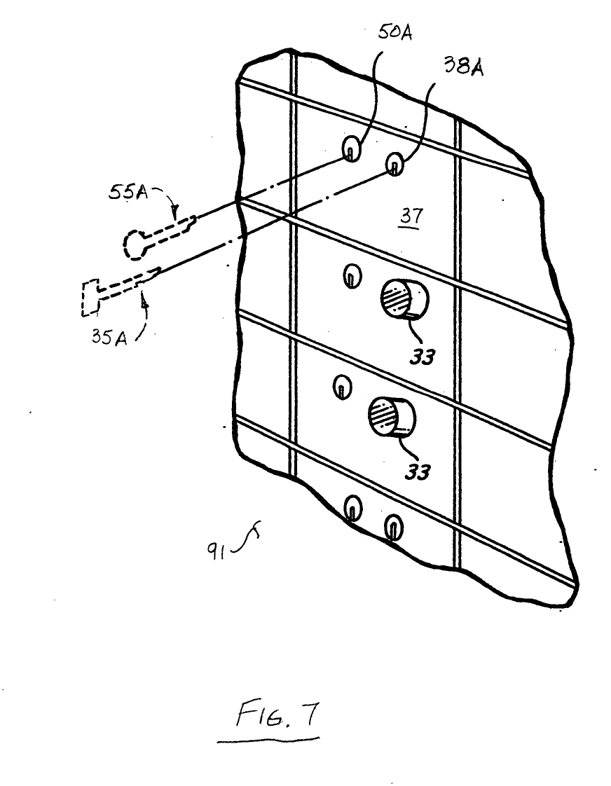

FIG. 6 is a block flow diagram illustrating a system which can be utilized with the vault entry system of the invention to facilitate renting, maintaining, and accessing safe deposit boxes;

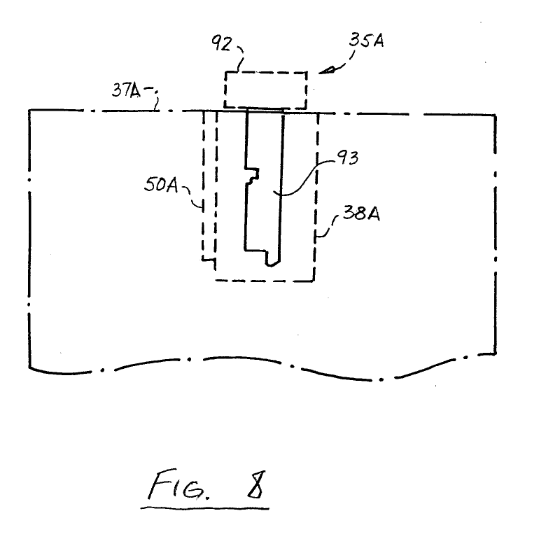

FIG. 7 is a perspective view illustrating an alternate embodiment of the invention; and,

FIG. 8 is a side view of the apparatus of FIG. 7 illustrating the mode of operation thereof.

Briefly, in accordance with my invention, I provide an improved storage system for safe keeping of a customer's valuable property. The improved storage system includes a vault; and, a plurality of safe deposit boxes stored in the vault and each including a first lock mounted in the box, a first key for opening the first lock, a second lock mounted in the box, and, a second key inserted in the second lock in a fixed position in which the second lock is opened. The improved storage system also includes apparatus mounted on each of the safe deposit boxes to engage the second key and permanently maintain the second key in its fixed unlocked position.

In a further embodiment of my invention, I provide an improved method for modifying a vault to facilitate a customer's accessing the vault. The vault includes an entrance; and, a plurality of safe deposit boxes stored in the vault and each including a first lock mounted in the box, a first key for opening the first lock, a second lock mounted in the box, and a second key. The second key is inserted in the second lock and is movable between at least two operative positions when inserted, a first operative position with the second lock locked, and, a second operative position with the second lock unlocked. The improved method includes the steps of inserting in each of the safe deposit boxes the second key in the second lock and moving the second key to the second operative position; and, permanently securing the second key in the second operative position.

In another embodiment of my invention, I provide an improved access system in combination with a storage area in a financial institution. The storage area includes a vault; a daygate for accessing the vault; and, a plurality of safe deposit boxes stored in the vault. Each safe deposit box includes a first lock mounted in the box; a first key for opening the first lock; a second lock mounted in the box; and, a second key for opening the second lock. The improved access system facilitates access to the storage area and includes a camera in the vault to photograph a customer entering the vault through the daygate; and, a control. The control receives, processes, and validates customer identification information; unlocks the daygate when the customer identification information is validated; and, transmits a control signal to the camera when the customer identification information is validated. The improved access system also includes apparatus at the daygate for inputting customer identification information to the control.

In still a further embodiment of my invention, I provide an improved method for equipping a vault to facilitate access to the vault. The vault includes a daygate for accessing the vault; and, a plurality of safe deposit boxes stored in the vault. Each safe deposit box includes a first lock mounted in the box; a first key for opening the first lock; a second lock mounted in the box; and, a second key for opening the second lock. The improved method includes the steps of installing a camera in the vault to photograph a customer entering the vault through the daygate; and, installing a control. The control receives, processes, and validates customer identification information; unlocks the daygate when the customer identification information is validated; and, transmits a control signal to the camera when the customer identification information is validated. The improved method also includes the step of installing communication apparatus at the daygate for inputting customer identification information to the control. The improved method can also include the step of installing apparatus for maintaining audio surveillance in said vault.

In still another embodiment of the invention, I provide an improved safe deposit system for a financial institution. The system includes a secure area including a walking area in the secure area; a door for accessing the secure area; and, a plurality of safe deposit boxes stored in the secure area. At least one of the boxes includes a face viewable from the walking area; only a single lock mounted in the face and viewable and accessible by a customer positioned in the walking area; and, a customer key operable by the customer positioned in the storage area to open and close the single lock to access and lock the one of the boxes. The single lock is operable using only the customer key. The system also includes a memory including customer identification verification information comprising reference data defining at least the customer; and, a control unit. The control unit includes a reader unit to obtain real time date defining the customer when the customer is attempting to enter the secure area; a system for comparing the reference data with the real time data; and, a system to unlock the door when the reference data corresponds to the real time data. The safe deposit system permits the customer to access the secure area and, using only the customer key, to access the one of the boxes.

In yet still a further embodiment of the invention, I provide an improved safe deposit system for a financial institution. The system includes a secure area including a walking area inside the secure area; a door for accessing the secure area; and, a plurality of safe deposit boxes stored in the secure area. At least one of the boxes includes a face viewable from the walking area; a customer lock mounted in the face and viewable and accessible by a customer positioned in the walking area and having an open position and a closed position; a guard lock mounted in the face and viewable from the walking area and having an open position and a closed position; and, a customer key operable by the customer positioned in the walking area to open and close the customer lock to access and lock the one of the boxes. The customer lock is operable to the open position of the customer lock using only said customer key, and when the guard lock is in the open position of the guard lock. The system also includes a molded polymer guard lock key in the guard lock positioned such that guard lock is maintained in the open position; a memory including customer identification verification information comprising reference data defining at least the customer; and, a control unit. The control unit includes a reader unit to obtain real time date defining the customer when the customer is attempting to enter the secure area; a system for comparing the reference data with the real time data; and, a system to unlock the door when the reference data corresponds to the real time data. The safe deposit system permits the customer to access the secure area and, using only the customer key, to access the one of the boxes.

In yet still another embodiment of the invention, I provide an improved method of adapting a safe deposit system in a financial institution to facilitate access by a customer. The safe deposit system includes a secure area. The secure area includes a customer walking area inside the secure area; a door to access the secure area; and, a plurality of safe deposit boxes stored in the secure area. At least one of the boxes includes a face viewable from the walking area; a customer lock mounted in the face and viewable and accessible by a customer positioned in the walking area and having an open position and a closed position; a guard lock mounted in the face and viewable from the walking area and having a open position and a closed, locked position; and, a customer key operable by the customer positioned in the walking area to open and close the customer lock to access and lock the one of the boxes. The customer lock is operable to the open position of the customer lock using only the customer key, and when the guard lock is in the open position of the guard lock. The secure area also includes a memory including customer identification verification information comprising reference data defining at least the customer; and, a control unit. The control unit includes a reader unit to obtain real time date defining the customer when the customer is attempting to enter the secure area; a system for comparing the reference data with the real time data; and, a system to open the door when the reference data corresponds to the real time data. The improved method comprises providing a mold to produce keys from a polymer material, the mold being modifiable to produce different keys to open different locks; modifying the mold to produce keys for the guard lock; and, using the mold to produce a molded polymer key for the guard lock. The polymer key has a head, and a body attached to the head and shaped and dimensioned to be inserted in and operate the guard lock when the key is turned by grasping and turning the head. The method also includes the steps of inserting the body of the polymer key in the guard lock; grasping the head; and, turning the head and the body to move the guard lock to the open, unlocked position such that the guard lock remains in the open, unlocked position.

Turning now to the drawings, which depict the presently preferred embodiment of the invention for the purpose of illustrating the practice thereof and not by way of limitation of the scope of the invention, and in which like reference characters refer to corresponding elements throughout the several views, FIGS. 1 to 5 illustrate an access and storage system constructed in accordance with the invention. The system includes a vault 40 (FIG. 3) having an entrance provided with a day gate and a day gate lock 20 (FIG. 4) in the day gate. One or more safe deposit boxes 36 are stored in the vault 40 or other secure area. Each box 36 includes a pair of side-by-side locks 50, 38. Each lock must be opened to open the safe deposit box. The first lock 50 on a box 36 ordinarily is opened with a key carried and provided by the customer. The first lock 50 is therefore referred to herein as the customer lock. The second lock 38 on box 36 ordinarily is opened with a guard-key 35 provided by the owner of the vault 40, which owner is typically a bank, savings and loan, credit union, or other financial institution. The second lock 38 is therefore referred to herein as the bank guard-lock. Guard-key 35 and the other key utilized to open box 36 are each operated in conventional fashion by inserting the distal end of the key in the appropriate lock, by manually grasping the proximate end or head of the key, and by turning the key to open the lock. In the practice of the invention, the guard-key 35 is inserted in bank guard-lock 38, is turned to the position at which bank guard-lock 38 is open, and is permanently maintained in this position (such that bank guard-lock 38 is permanently open) by sliding rectangular slot 32 of cylindrical member 30 over the head of key 35 in the manner shown in FIG. 3 such that adhesive layer 34 on the bottom of member 30 contacts the face plate 37 of box 36 and permanently secures member 30 to plate 37 in the position illustrated in FIG. 3. Face plate 37 typically comprises a hinged door. When the door is unlocked and opened, a container, called a box-tin, in box 36 can be pulled outwardly and completely removed from box 36 such that a customer can examine the contents of the box-tin. When member 30 is permanently secured in the position illustrated in FIG. 3, guard-key 35 is maintained in bank guard-lock 38 in a position which maintains bank guard-lock 38 in a permanently open position. Each safe deposit box 36 can, if desired, include only a single lock 50 and not be equipped with a guard lock 38. One advantage of a single lock 50 is that a guard lock key 35 and member 50 need not be utilized. When a single lock 50 is utilized, it is preferred that key 55 by itself be sufficient to open and close lock 38 and, therefore, be sufficient to open and access and to lock and close the safe deposit box. Some existing safe deposit box systems appear to utilize a single lock 50 and a key 55 that can be used to manually open the lock 50. However, an additional control, or locking, system is utilized in conjunction with lock 50 such that lock 50 can not be fully opened until the additional control system releases or enables lock. This is equivalent to having a conventional safe deposit box with two locks-a customer lock 50 and a guard lock 38 that must be opened before the customer lock 50 can be opened. One important objective of the invention is to simplify, and not further complicate, a safe deposit box system. Having a safe deposit box with two locks, or with a single lock that is controlled by an auxiliary lock system, defeats this objective of the invention. Since the vault entry system utilized in the invention verifies the identify of the person entering the vault, the need for a guard lock 38 or other comparable guard system is obviated and only a single customer lock 38 needs to be utilized in a safe deposit box. Member 30 is, however, still useful in existing two key safe deposit boxes, of which there are many. Lock 50 can be mechanically operated and key 55 can be a conventional mechanical key, as illustrated in FIG. 3A, or lock 50 can be electronic and be opened with a key comprising a plastic card (in the manner that many hotel rooms are presently opened), with a key comprising an electronic control unit, or with any other desired means that is operatively associated with and functions as a key to open lock 50.

Member 30 also includes upper circular surface 33 and outer cylindrical surface 39. An arrow 31 can, if desired, be formed on surface 33 to indicate the location and orientation in member 30 of the slot 32. The orientation of slot 32 in member 33 can also be indicated by forming member 30 with a dimension or shape which corresponds to and indicates the orientation of slot 32 in member 33. Arrow 31 indicates the orientation of slot 32 in member 33 because arrow 31 is parallel to and coincident with an imaginary plane which both bisects slot 32 and is spaced apart and parallel to the opposing parallel spaced apart pair of rectangular sides 51, 52 of slot 32 which sides each have a greater surface area than the other pair of opposing parallel spaced apart pair of rectangular side of slot 32.

As will be appreciated by those of skill in the art, any desired means can be utilized to secure a guard-key 35 in bank guard-lock 38 a position to maintain the bank guard-lock 38 of a safe deposit box open. By way of example and not limitation, guard-key 35 can be welded in a fixed position or the bank guard-lock 38 can be secured in an open position without requiring that guard-key 38 be continuously inserted in bank guard-lock 38, i.e., guard-key 35 is inserted in guard-lock 38 and used to open guard-lock 38, after which guard-lock 38 is welded or otherwise permanently secured in an open position and key 35 is removed from guard-lock 38.

Additional components of the access and storage system of the invention are illustration in FIG. 4. A microprocessor or other computer or control device is mounted in vault 40, outside of vault 40, or at any other desired location in or remote from the building or other location in or at which vault 40 or another secure area is located. The microprocessor includes controller 10 and memory 11. The controller 10 includes an entrance program 13 and an exit program 12. Memory 11 includes entrance information 14 and exit information 11. As used herein, a secure area is one that requires the input of customer identification information for the customer to access the secure area. Customer identification information is information that satisfies entry criteria that are defined as required to permit access into and use of the secure area. Some examples, without limitation, of customer identification information are the customer's PIN number, the customer's fingerprint, the customer's DNA, a credit card, the customer's bank card, and, the customer's social security number. The customer identification information can be obtained by a bank employee, but preferably is obtained by or input into an electronic device that opens a door or otherwise grants access to the secure area once acceptable customer identification information is obtained. The electronic device can, by way of example and not limitation, comprise card reader, a keyboard, a fingerprint reader, or a retina scan reader. Customer identification information obtained by the electronic device is preferably compared with information on file in a computer or other storage area to confirm the identity of the customer. One example of a secure area other than a vault is the building in which a bank or other institution conducts business. Another example of a secure area other than a vault is in area inside a bank building that includes safe deposit boxes, and is cordoned off with a wall, a wrought iron fence, etc.

While entrance information 14 can vary as desired, such information presently includes desired customer identification data for each customer expected to access a safe deposit box in vault 40 or in another secure area. Since in many cases the vault 40 or other secure area is owned by a bank, the customer identification data can include the number on the customer's bank card, the expiration date of the card, and the customer's PIN number. The customer's name and address, birth date, social security number, and any other desired customer identification information can be stored in entrance information 14. Such customer identification information is utilized by the entrance program 13 of controller 10 to confirm the identity of a customer attempting to access vault 40. The entrance information can also, if desired, included digitized data sent 48 by cameras 16, 18 to define the picture(s) of the customer taken by camera 16, 18 when the customer enters (or exits) vault 40 through the day gate or other entrance to vault 40. Alternatively, such data can be stored in camera 16, 18 or at another desired location. The data sent 48 or stored in camera 16, 18 or at another desired location can, if desired, be digitized. Camera 18 presently preferably, but not necessarily, is outside the day gate and takes a full frontal (head-to-toe) view picture of the customer, and, when the customer walks through the day gate into the vault, takes a picture of the back of the customer. Camera 16 presently preferably, but not necessarily, is inside the vault and day take and takes a picture of the upper body and head of the customer as the customer enters the vault so that a larger view of the customer's face is produced. Cameras 16, 18 are also used to view the front and back of the customer when the customer exits the vault.

The exit information 15 can include any desired information, but presently includes information used by exit program 12 of controller 10 to open day gate lock 20 when exit button 19 is touched, depressed, or otherwise activated by a customer who is inside vault 40 and wishes to exit vault 40. Exit information 15 can also include digitized data sent 46 from cameras 16, 18 to define the picture(s) of the customer taken by camera 16, 18 when the customer exits vault 40 through the day gate or other entrance to vault 40. Alternatively, such data can be stored in camera 16, 18 or another desired location in an analog, digital, or other desired format.

A card reader 17 or other identification device is ordinarily mounted at or adjacent to the day gate to the vault but can be mounted at any desired location where it is accessible to a customer standing outside the vault. Card reader 17 presently preferably includes a magnetic strip reader for reading the customer identification information contained in magnetic strip on a bank card, ATM card, credit card, or other card and for sending 41, 40 a signal containing pertinent customer identification information to controller 10 and memory 11, respectively. Reader 17 can include any other desired sensor means for reading customer identification information contained on or in a card or other member or apparatus utilized by a customer to gain entrance to vault 40. Reader 17 also presently preferably includes a numeric or alphanumeric key pad which permits a customer to enter his or her PIN number or other code number. Reader 17 can also include means for analyzing a customer's voice to identify the customer, for analyzing a customer's eye with a retina scan, for reading the hand geometry (i.e., the shape and dimension of a customer's hand) of a customer, for scanning the vein pattern in a person's hand, for analyzing a customer's fingerprint, for genetically analyzing tissue or a cell from the customer, and/or for analyzing any other desired characteristic or property of a customer to obtain information which facilitates uniquely defining and identifying the customer. A sign adjacent reader 17 can, if desired, be provided to instruct a customer to “INSERT AND REMOVE YOUR ATM CARD AND ENTER YOUR FOUR DIGIT PIN TO ENTER VAULT.” Once a customer enters the vault 40, another customer who wishes to enter the vault 40 is altered by a warning sign which states: “ONE MOMENT PLEASE. VAULT IS OCCUPIED.” This warning sign lights up as soon as a customer enters vault 40. Controller 10 can be set to not allow another customer in vault 40 until the customer in the vault exits the vault.

Day gate lock 20 receives 42 a signal from controller 10 which unlocks the day gate lock to permit a customer to enter vault 40 through the day gate.

Inside camera 16 is mounted inside vault 40 and receives 43 a signal from control 10 when a customer is entering vault 40 through the day gate. When a customer enters vault 40 through the day gate, camera 16 records a picture of the customer from the waist up, along with the date and time of day that the customer enters the vault 40. If desired, the camera 16 can photograph only the head and shoulders of the customer, can photograph the customer from head to toe, etc. When a customer enters vault 40, the customer see a prominently displayed sign: “IF YOU REQUIRE AN ASSISTANT, PLEASE LET US KNOW AND WE WILL BE HAPPY TO ASSIST YOU. THIS AREA IS UNDER CLOSED CIRCUIT TELEVISION AND/OR AUDIO SURVEILLANCE AT ALL TIMES FOR YOUR PROTECTION.”

Outside camera 18 is mounted outside vault 40 and receives 45 a signal from controller 10 when a customer is exiting vault 40 through the day gate. When a customer exits the vault 40 through the day gate, camera 18 records a picture of the customer from head to toes, along with the date and time of day that the customer exits the vault 40.

The exit button 19 is mounted inside vault 40, typically near the vault's day gate. When a customer inside the vault wishes to exit through the day gate, he or she depresses button 19 to send 44 a signal to controller 10. A sign near the exit button instructs a customer to “PUSH BUTTON TO EXIT THIS AREA.” An intercom phone can be installed adjacent the exit button 19 or at any other location in vault 40. A sign adjacent the intercom phone instructs a customer to “FOR ASSISTANCE PICK-UP PHONE AND A TELLER WILL ASSIST YOU.”

FIG. 5 is a block flow diagram which illustrates a typical program or logic function which is executed by the controller 10 to permit access to vault 40. The basic control program 61 consists of commands to “start and initialize” 62, “read memory” 63, and “transfer control” 64 to the entry program sub-routine 60 or the exit program sub-routine 50.

The entry program sub-routine 60 includes a command to “interpret memory” 67 (i.e., to determine if the customer identification information which is gathered by card reader 17 from a bank card or other source of information and which is received and processed by program 13 can be confirmed and validated). When the customer identification information is validated, the command “activate inside camera and unlock day gate” 68 causes controller 10 to activate 43 cameras 16,18 and to open 42 the day gate or other entrance to the vault 40, followed by the command “return to control program” 69. In the event the customer identification information is not validated (which would be unusual), then controller 10 does not activate cameras 16, 18 and open the day gate 20 and the command “return to control program” 69 is followed.

The exit program sub-routine 50 includes a command to “activate cameras and unlock day gate” 71 followed by “return to control program” 72. The exit program sub-routine 50 is activated whenever a customer in vault 40 depresses the exit button 19 to produce a signal 44 transmitted to controller 10.

In use, a bank or other business or financial institution has a vault or other secure area in which safe deposit boxes 36 are stored. Each safe deposit box 36 includes two locks, a customer lock and a bank lock, mounted side-by-side in the face 37 of the box. The customer lock is opened with a key kept by the customer. The bank lock is opened with a key kept by the bank.

The bank obtains a member 30 for each safe deposit box. The guard-key 35 for the bank guard-lock 38 on each box is inserted in the bank guard-lock by bank personnel who then turn the key to open the bank guard-lock. Member 30 is slid over the head of guard-key 35 such that contact adhesive 34 on the bottom surface of member 30 contacts and permanently adheres to the face 37 to permanently maintain guard-key 35 in a position which permanently maintains bank guard-lock 38 open.

The bank installs a microprocessor, installs a card reader 17 outside the day gate to the vault, installs a camera 16 which is inside the vault and is focused on the day gate to photograph a customer entering and leaving the vault, installs a camera 18 which is outside the vault and is focused on the day gate to photograph a customer leaving and entering the vault, and, installs an exit button 19 which is inside the vault 40 and is depressed by a customer who wishes to exit vault 40. The microprocessor includes controller 10 and memory 11. Controller 10 includes entrance program 13 and exit program 12. Memory 11 includes entrance information 14 and exit information 15. The controller 10, camera 16, camera 18, card reader 17, exit button 19, and day gate lock 20 generally function in the manner earlier described herein.

A customer who is renting a safe deposit box 36 in vault 40 and has a key for the customer lock in the box 36 enters the bank and walks up to the day gate of vault 40. The customer uses his (or her) bank card by running the magnetic strip of the card through a card reader which is part of card reader 17. The customer also utilizes a keyboard on reader 17 to enter his PIN number. The PIN number and customer identification information contained in the magnetic strip of the customer's bank number are transmitted 41 to the controller 10 and to entrance information 14 in memory 11. Receipt of the customer identification information by controller 10 activates the entrance program 13. Program 13 processes 67 the customer identification information transmitted 41 by reader 17 by comparing the customer identification information to customer identification information which was earlier stored in entrance information 14. If such comparison confirms that the customer awaiting entry to vault 40 is a customer of the bank and has a safe deposit box in vault 40, the program validates the customer identification information received from reader 17 and authorizes activation of cameras 16, 18 and the unlocking of the day gate so the customer can walk through the day gate into vault 40. Controller 10 sends 42 a signal to the day gate lock 20 to unlock the day gate. Customer identification information ordinarily is validated by program 13 if it matches and corresponds to customer identification information earlier verified by the bank and entered into memory 11 as entrance information 14.

If the customer identification information received by the controller from reader 17 is validated by program 13, the controller also, in accordance with program 13, sends 43 a signal to cameras 16, 18. While signal 43 can perform any desired function with respect to cameras 16 and 18, signal 43 presently turns on cameras 16 and 18 while the customer enters vault 40 through the day gate. Cameras 16,18 take pictures of the customer while he (or she) walks through the day gate into the customer walking area 91 provided in the vault. If the customer is in wheelchair, the customer moves the wheelchair into the customer walking area 91. The lock or locks 50 and 38 mounted in the face of the customer's safe deposit box can be seen and accessed by the customer when the customer is in a portion of area 91 near or adjacent the customer's safe deposit box.

Once the customer is inside the vault 40 in area 91, the customer goes to his safe deposit box and utilizes his key to open the customer lock on the box. Since the bank guard-lock on the box is maintained in a permanently open position by guard-key 35 and member 30 in the manner earlier described, once the customer uses his key to open the customer lock, the customer can remove the box 36 from its original location in vault 40 and examine the inside of the box. In another embodiment of the invention described above, there is no bank guard-lock in the box and, instead, there is only a customer lock in the safe deposit box. This single lock, the customer lock, is opened by the customer to gain access to box 36.

The customer can examine the box-tin in box 36 in the vault or in a room outside the vault. The customer then reinstalls the box in its original location and uses his key to lock the customer lock to secure the box-tin in box 36 in vault 40. The customer walks to the day gate and depresses button 19. Button 19 sends 44 a signal to the controller 10. Controller 10 activates the exit program 12. Program 12 directs 71 that cameras 16, 18 be activated and that the day gate be unlocked. Accordingly, controller 10 sends 42 a signal which unlocks lock 20 and sends 45 a signal which causes cameras 16, 18 to take photographs of the customer while he exits vault 40 through the day gate.

Photographs of a customer taken by cameras 16, 18 are transmitted 48, 47 to entrance information 14 and exit information 15, respectively, for storage and later recall. An additional camera(s) can be provided in the vault to view a customer when the customer is opening his or her safe deposit box. Such a camera(s) can, if desired, be utilized to view in whole or in part a customer during the entire time or a portion of the time the customer is in the vault.

If desired, in the practice of the invention the customer lock on a safe deposit box can be permanently maintained in an open position and the bank lock can be allowed to continue to function in its normal manner and can (instead of the customer lock) be used to open and close the safe deposit box.

When a customer enters a bank vault containing the customer's safe deposit box, an audible announcement can be played through speakers inside the vault 25 which informs the customer that he or she has a set period of time (for example, three minutes) to open a safe deposit box and leave the vault. The customer can quickly open and close the safe deposit box in this period of time or can open the safe deposit box and remove and carry the box-tin which is in the box out of the vault to a room in the bank where the customer can examine the contents of the box-tin at the customer's leisure. If, at the end of the prescribed period of time (for example, three minutes), the customer has not left the vault, another audible announcement can be played through speakers in the vault which inform the customer that he or she must leave the vault immediately. The system of the invention ordinarily, as described above, can detect when a customer enters and leaves the bank vault.

FIG. 6 illustrates a system which can be utilized with the vault entry system of the invention to facilitate renting, maintaining, and accessing safe deposit boxes. The system includes a controller 90, memory 91, output 84, data input re SDB (safe deposit box) rental 83, and data input re vault visitation 82. Memory 91 can be constructed utilizing paper tape to store data, utilizing cards to store data, utilizing magnetic tape to store data, utilizing a hard disk in a computer, or utilizing any other desired means.

Memory 91 includes rental information 89 and vault visitation information 88. The controller 90 includes SDB rental sub-routine 81 and vault visitation sub-routine 80.

Rental information 89 can, by way of example and not limitation, include:
1. Record keeping history including the date on which each safe deposit box is rented and the length of time each box has been rented by a particular person or person(s).
2. Box rental history including whether or not each box is presently rented, whether the box is on a waiting list, the size of the box, whether the box is low and close to the vault floor, whether the box is high and is located relatively far above the vault floor, etc.
3. Box payment audit trail including whether the rent for the box has been paid, whether the payment was made on time, whether rent is due on the box.
4. Vault SDB configuration including the location of each box in the vault, including the location in the vault of boxes which may be imported from another bank which has closed, and including the original numbers on boxes imported from another bank (i.e., where the box number was SDB 100, which was SDB 101, etc. in the old bank) and the new numbers, if any, assigned to the boxes when the boxes arrived at the current bank.
5. Waiting lists for SDB's including a list of clients waiting for a SDB to become available to rent.

Vault visitation information 88 can, by way of example and not limitation, include:
1. An access audit trail including a record of the days and/or times when a person renting a SDB enters the vault or open his or her SDB.
2. Downloadable market data including a record of the number of people who visit the vault on each day of the week, during each week of the year, and during each month of the year.
3. Sorting of access data including the number of times during a week, month, or year a person renting the box entered the vault.

The rental information 89 is provided by data input re SDB rental 83. Data input 83 can comprise any means for inputting data but presently typically is a computer keyboard utilized by a bank employee to input data.

Output 84 can comprise a printer, computer screen, or any other means for outputting data.

The vault visitation information 88 is provided by data input re vault visitation 82. Data input 82 can comprise any means for inputting data but presently typically is controller 10 in FIG. 4.

Each time a customer enters the vault, controller 10 supplies vault visitation information 88 in memory 91 with identification information identifying customer entering the vault. This identification information can include the name of the customer, the customer's phone number and e-mail, the number of the customer's bank card, the customer's fingerprint, etc. Controller 10 also supplies vault visitation information 88 with the date, the time(s) the customer entered the vault on that date, the number of the customer's SDB, and the time(s) when the customer leaves the vault on that date.

Whenever a SDB is rented, a bank employee uses data input 83 to supply rental information 89 with the number of the safe deposit box, the date the box is rented, the name(s) of the customers renting and having access to the box, the rental fee payable by the customer periodically throughout the year, the length of time for which rent has been received from the customer, the customer's billing address, the number of keys given the customer, the size of the box, the location of the box in the vault, and the position (high or low) of the box with respect to the vault floor. If the box is a box brought from another bank and placed in the vault, the old number of the box is provided rental information 89, along with the new number assigned the box, if appropriate.

Whenever a customer puts his name on a waiting list to rent a SDB, the customer's name, address, phone number, and e-mail are provided to rental information 89, along with the date on which the customer's name is added to the waiting list and the size and location (high or low from vault floor) of the SDB in which the customer is interested.

In use of the system of FIG. 6, on the 1^{st} of each month, a bank employee can use data input 83 to enter data requesting controller 90 to preparing a monthly 25 (quarterly, yearly, etc.) billing statement for each SDB in the bank's vault. The SDB rental sub-routine 81 interrogates rental information 89 to determine which boxes are rented, the name and address of the customer renting each box, and the amount in dollars owed by the customer as rent. A bank employee then mails the statements printed by output 84.

If a customer wishes to rent a SDB, but all SDB's are taken, a bank employee can use data input 83 to place, if the customer wishes, the customer's name on a waiting list stored in rental information 89.

If a customer wishes to rent a SDB, and boxes are available for rental, a bank employee can enter data via data input 83 which causes controller 90 to use SDB rental sub-routine 81 to obtain from rental information 89 and print out or display on output 84 the list of available box numbers, including the size and rental rate for each box and the location of the box (high or low) with respect to the floor of the vault.

If the bank wishes to analyze the frequency of vault use on particular days or at particular times of the day, a bank employee utilizes data input 83 to enter data which prompts controller 90 to initiate vault visitation sub-routine 80 to recall data from vault visitation information 88 to determine and print out or display in output 84 how many times during each day of a month a vault was visited by customers, to determine at which times of the day the vault was visited, and, if desired, to total for any given month the number of customers visiting (1) on Monday, Tuesday, Wednesday, Thursday, Friday, (2) during each week, and (3) during the whole month. For each bank customer, a bank employee can also utilize data input 83 to enter data which prompts controller 90 to initiate sub-routine 80 to recall data from information 88 to determine and print out or display in output 84 the days and time during any given month that any particular customer visited the bank vault.

In FIG. 3A lock 50 on a box 36 is opened with a key 55 provided by the customer, while lock 38 is opened with a guard-key 35 provided by the owner of the vault.

An alternate embodiment of the invention is illustrated in FIGS. 7 and 8 and includes the use of a key 35A. Key 35A can be made from any desired material but preferably is molded or otherwise formed from plastic or other polymer and includes a head 92 and a body 93. The mold is adjustable or adaptable so it can be reset or modified to mold keys 35A having bodies 93 of differing shape, i.e., so the mold can be used to make keys 35A for different locks 38A. Procedures for making a mold that can be modified to produce polymer keys of differing shape and dimension are, once the goal of producing different polymer keys for different safe deposit box locks has been identified, known and are not described herein. Safe deposit box keys have been made from metal for many years and such keys have been prepared one-by-one by cutting a metal blank. The mold of the invention significantly reduces the time and cost required to make a safe deposit box key. If desired, the key can be fabricated from a polymer that is relatively strong and tough and difficult to break.

Key 35A is used in conjunction with a safe deposit box that has a customer lock 50A and a guard lock 38A mounted in the face, or face plate, 37A of the safe deposit box. Customer lock 50 is opened with a key 55A carried by the customer that rents or owns the box and who is standing or is otherwise positioned in walking space 91 that is commonly found in a vault and is in front of or adjacent face 37A of the safe deposit box. Guard lock 38A is normally opened by an employee who is standing or is otherwise positioned in walking space 91 and who has a guard key that opens lock 38A and that is provided by the bank or other institution in which the safe deposit box is located. As noted earlier, the guard key 35A must be used to open lock 38A before customer lock 50 can be opened with key 55A. Guard key 35A is made such that body 93, when inserted in lock 38A, can be manually manipulated by grasping and turning head 92 (and therefore body 93) to open and close mechanical lock 38A in conventional fashion. Once installed, key 35A can simply be left in lock 38A for a customer to use to open lock 38A, can be left in lock 38A with lock 38A in the open position, or can be left in lock 38A with lock 38A in the open position and with member 30 installed over head 92 with slot 32 over head 92 and adhesive layer 34 fixedly secured to face plate 37 in the manner earlier described and illustrated in FIG. 3A. Installing member 30 maintains key 35A in lock 38A with lock 38A in the open position.

Having described my invention in such terms as to enable those skilled in the art to understand and practice it and having described the presently preferred embodiments thereof, I claim:

1. A safe deposit system for a financial institution, said system including
(a) a secure area including
(i) a walking area in said secure area,
(ii) a door for accessing said secure area,
(iii) a plurality of safe deposit boxes stored in said secure area, at least one of said boxes including
(A) a face viewable from said walking area,
(B) only a single lock mounted in said face and viewable and accessible by a customer positioned in said walking area,
(C) a customer key operable by said customer positioned in said storage area to open and close said single lock to access and lock said one of said boxes, said single lock operable using only said customer key;
(b) a memory including customer identification verification information comprising reference data defining at least said customer;
(c) a control unit including
(i) a reader unit to obtain real time date defining said customer when said customer is attempting to enter said secure area,
(ii) a system for comparing said reference data with said real time data, and
(iii) a system to open said door when said reference data corresponds to said real time data;
said safe deposit system permitting said customer to access said secure area and, using only said customer key, to access said one of said boxes.

2. A safe deposit system for a financial institution, said system including
(a) a secure area including
(i) a walking area inside said secure area,
(iii) a door for accessing said secure area,
(iv) a plurality of safe deposit boxes stored in said secure area, at least one of said boxes including
(A) a face viewable from said walking area,
(B) a customer lock mounted in said face and viewable and accessible by a customer positioned in said walking area and having an open position and a closed position,
(C) a guard lock mounted in said face and viewable from said walking area and having an open position and a closed position,
(D) a customer key operable by said customer positioned in said walking area to open and close said customer lock to access and lock said one of said boxes, said customer lock operable to said open position of said customer lock
(i) using only said customer key, and
(ii) when said guard lock is in said open position of said guard lock,
(E) a molded polymer guard lock key in said guard lock positioned such that guard lock is maintained in said open position;
(b) a memory including customer identification verification information comprising reference data defining at least said customer;
(c) a control unit including
(i) a reader unit to obtain real time date defining said customer when said customer is attempting to enter said secure area,
(ii) a system for comparing said reference data with said real time data, and
(iii) a system to open said door when said reference data corresponds to said real time data;
said safe deposit system permitting said customer to access said secure area and, using only said customer key, to access said one of said boxes.

3. A method of adapting a safe deposit system in a financial institution to facilitate access by a customer, the safe deposit system including
a secure area including
(i) a customer walking area inside said secure area,
(ii) a door for accessing said secure area,
(iii) a plurality of safe deposit boxes stored in the secure area, at least one of said boxes including
(A) a face viewable from said walking area,
(B) a customer lock mounted in said face and viewable and accessible by a customer positioned in said walking area and having an open position and a closed position,
(C) a guard lock mounted in said face and viewable from said walking area and having a open position and a closed, locked position,
(D) a customer key operable by said customer positioned in said walking area to open and close said customer lock to access and lock said one of said boxes, said customer lock operable to said open position of said customer lock
(i) using only said customer key, and
(ii) when said guard lock is in said open position of said guard lock;
a memory including customer identification verification information comprising reference data defining at least said customer;
a control unit including
(i) a reader unit to obtain real time date defining said customer when said customer is attempting to enter said secure area,
(ii) a system for comparing said reference data with said real time data, and
(iii) a system to open said door when said reference data corresponds to said real time data;
said method comprising
(a) providing a mold to produce keys from a polymer material, said mold being modifiable to produce different keys to open different locks;
(b) modifying said mold to produce keys for said guard lock;
(c) using said mold to produce a molded polymer key for said guard lock, said polymer key having
(i) a head, and
(ii) a body attached to said head and shaped and dimensioned to be inserted in and operate said guard lock when said key is turned by grasping and turning said head;
(b) inserting said body of said polymer key in said guard lock;
(c) grasping said head; and,
(d) turning said head and said body to move said guard lock to said open, unlocked position such that said guard lock remains in said open, unlocked position.
